(19) United States
(12) Patent Application Publication
(10) Pub. No.: US 2022/0081262 A1
(43) Pub. Date: Mar. 17, 2022

(54) DYNAMIC-LIFT-OFF DETERMINATION DEVICE, DYNAMIC-LIFT-OFF CONTROL DEVICE, MOBILE CRANE, AND DYNAMIC-LIFT-OFF DETERMINATION METHOD

(71) Applicant: TADANO LTD., Kagawa (JP)

(72) Inventor: Yoshimasa MINAMI, Kagawa (JP)

(73) Assignee: TADANO LTD., Kagawa (JP)

(21) Appl. No.: 17/421,629

(22) PCT Filed: Feb. 14, 2020
(86) PCT No.: PCT/JP2020/005710

§ 371 Date: Jul. 8, 2021

(30) Foreign Application Priority Data
Feb. 14, 2019 (JP) 2019-024611

(51) Int. Cl. B66C 13/46; B66C 13/16; B66C 13/18

(52) U.S. Cl. CPC B66C 13/46; B66C 23/36; B66C 13/18; B66C 13/16

(57) ABSTRACT

Provided is a dynamic-lift-off determination device capable of quickly performing a dynamic-lift-off determination by a simple method, while suppressing swinging of a load. A dynamic-lift-off determination device C includes: a boom 14 that is configured so as to be freely raised and lowered; a winch 13 that lifts/lowers a suspended load via a wire rope 16; a load-weight measuring means 22 that measures a load weight acting on the boom 14; a rope-length and lifting-speed measuring means 24 that measures the rope length of the wire rope 16; and a control unit 40 that controls the boom 14 and the winch 13 and that determines, when the winch 13 winds up the rope to dynamically lift off the suspended load, the dynamic lift off on the basis of a temporal change in the measured load weight and a temporal change in the measured rope length.

### TECHNICAL FIELD

The present invention relates to a lifting determination apparatus for suppressing a load swing when a suspended load is suspended from the ground.

### BACKGROUND ART

In the related art, there has been a problem of “load swing” that when a crane including a boom suspends a suspended load from the ground, that is, lifts a suspended load, the suspended load swings in the horizontal direction due to an increase in the working radius by a deflection generated in the boom (see FIG. 1).

For the purpose of preventing a load swing during lifting, a vertical lifting control apparatus described in Patent Literature (hereinafter, referred to as “PTL”) 1, for example, is configured to detect an engine rotational speed by an engine rotational speed sensor and to correct a raising operation of a boom to a value corresponding to the engine rotational speed. Such a configuration is supposed to make it possible to perform an accurate lifting control in which changes in the engine rotational speed are taken into consideration.

### CITATION LIST

### Patent Literature

### PTL 1

Japanese Patent Application Laid-Open No. H08-188379

### SUMMARY OF INVENTION

### Technical Problem

However, lifting control apparatuses in the related art including that of PTL 1 determine lifting based on a time series of load data, and therefore have a problem that the responsiveness is poor and it takes time to determine lifting.

An object of the present invention is therefore to provide a lifting determination apparatus, a lifting control apparatus, a mobile crane, and a lifting determination method that are capable of quickly performing lifting determination by a simple method while suppressing a load swing.

### Solution to Problem

In order to achieve the above-described object, a lifting determination apparatus of the present invention includes: a boom configured to be freely luffed up and down; a winch that hoists and lowers a suspended load via a wire rope; a load measurement section that measures a load acting on the boom; a rope-length measurement section that measures a rope length of the wire rope; and a control section that controls the boom and the winch. When lifting of the suspended load is performed by hoisting the winch, the control section determines the lifting based on a temporal change in the measured load and a temporal change in the measured rope length.

Further, a lifting control apparatus of the present invention includes the lifting determination apparatus. When the lifting of the suspended load is performed by hoisting the winch, the control section determines a variation in a luffing angle of the boom based on the temporal change in the measured load, and causes the boom to be luffed up and down so as to compensate for the variation.

### Advantageous Effects of Invention

As described above, the lifting determination apparatus of the present invention includes a boom, a winch, a load measurement section, a rope-length measurement section, and a control section. When lifting is performed, the control section determines the lifting based on a temporal change in a measured load and a temporal change in a measured rope length. Given such a configuration, the lifting determination apparatus is capable of quickly performing lifting determination by a simple method while suppressing a load swing.

Further, the lifting control apparatus of the present invention includes the lifting determination apparatus. When the lifting is performed, the control section determines a variation in a luffing angle of the boom based on the temporal change in the measured load, and causes the boom to be luffed up and down so as to compensate for the variation.

Given such a configuration, the lifting control apparatus is capable of quickly performing lifting determination and quickly lifting a suspended load while suppressing a load swing.

### BRIEF DESCRIPTION OF DRAWINGS

FIG. 1 is a diagram for describing a load swing of a suspended load:

FIG. 2 is a side view of a mobile crane;

FIG. 3 is a block diagram of a lifting control apparatus:

FIG. 4 is a graph illustrating a load-luffing angle relationship;

FIG. 5 is a block diagram of the lifting control apparatus in its entirety;

FIG. 6 is a block diagram of lifting control:

FIG. 7 is a flowchart for the lifting control;

FIGS. 8A to 8C are graphs for describing the concept of lifting determination; and

FIG. 9 is a flowchart for describing a lifting determination method.

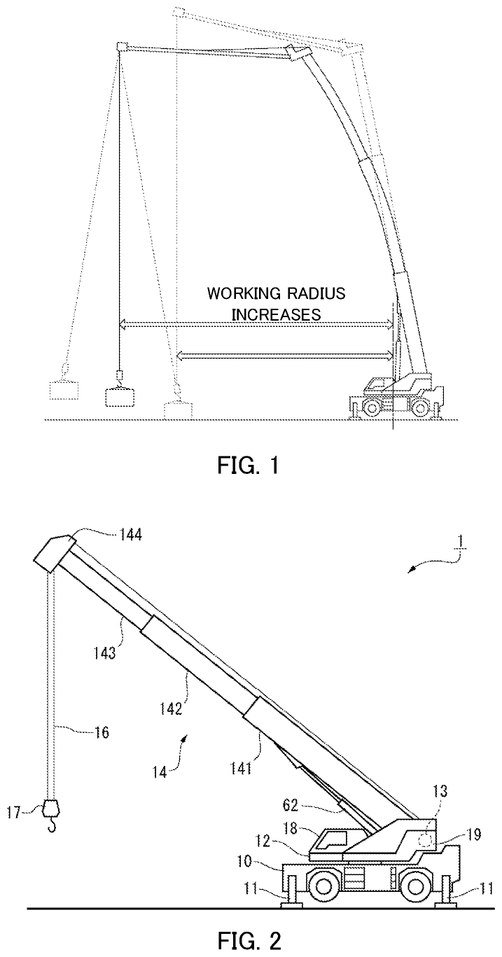

### DESCRIPTION OF EMBODIMENTS

Hereinafter, an embodiment according to the present invention will be described with reference to the accompanying drawings. It should be noted that the constituent elements described in the following embodiment are examples, and that the technical scope of the present invention is not intended to be limited only thereto.

### Embodiment

In the present embodiment, as a mobile crane, it is possible to mention, for example, a rough terrain crane, an all terrain crane, a truck crane, and the like.

Hereinafter, as a work vehicle according to the present embodiment, a rough terrain crane will be described as an example, but a safety apparatus according to the present invention is also applicable to other mobile cranes.

(Configuration of Mobile Crane)

First, a configuration of the mobile crane will be described using a side view of FIG. 2. As illustrated in FIG. 2, rough terrain crane 1 of the present embodiment includes vehicle body 10, outrigger 11, swivel base 12, and boom 14. Vehicle body 10 serves as a main body portion of a vehicle having a traveling function. Outrigger 11 provided at each of the four corners of vehicle body 10. Swivel base 12 is attached to vehicle body 10 in a horizontally swivelable manner. Boom 14 is attached to the rear of swivel base 12.

Outrigger 11 is capable of slide-extending or slide-housing outward in the width direction from vehicle body 10 by extending or retracting a slide cylinder. Outrigger 11 is also capable of jack-extending or jack-housing in the vertical direction from vehicle body 10 by extending or retracting a jack cylinder.

Swivel base 12 includes a pinion gear to which the power of swivel motor 61 is transmitted. Swivel base 12 turns around a swivel shaft by meshing of the pinion gear with a circular gear provided in vehicle body 10. Swivel base 12 includes cockpit 18 disposed in the right front, and counter weight 19 disposed in the rear.

Further, winch 13 for hoisting and lowering wire 16 is disposed in the rear of swivel base 12. Winch 13 rotates in two directions of a hoisting direction (taking-up direction) and a lowering direction (feeding-out direction) by rotating winch motor 64 in the forward direction or the backward direction.

Boom 14 is formed of base-end boom 141, (one or a plurality of) intermediate boom(s) 142, and distal-end boom 143 in a telescopic manner, and is extendable and retractable by telescopic cylinder 63 disposed inside boom 14. A sheave is disposed at boom head 144 at the most distal end of distal-end boom 143. Wire rope 16 is wound around the sheave, and hook 17 is suspended from wire rope 16.

Base-end boom 141 includes a base portion that is turnably attached to a support shaft disposed on swivel base 12. Base-end boom 141 can be luffed up and down with the support shaft as the center of rotation. Further, luffing cylinder 62 is stretched between swivel base 12 and a lower surface of base-end boom 141. Boom 14 in its entirety can be luffed up and down by extending and retracting luffing cylinder 62.

(Configuration of Control System)

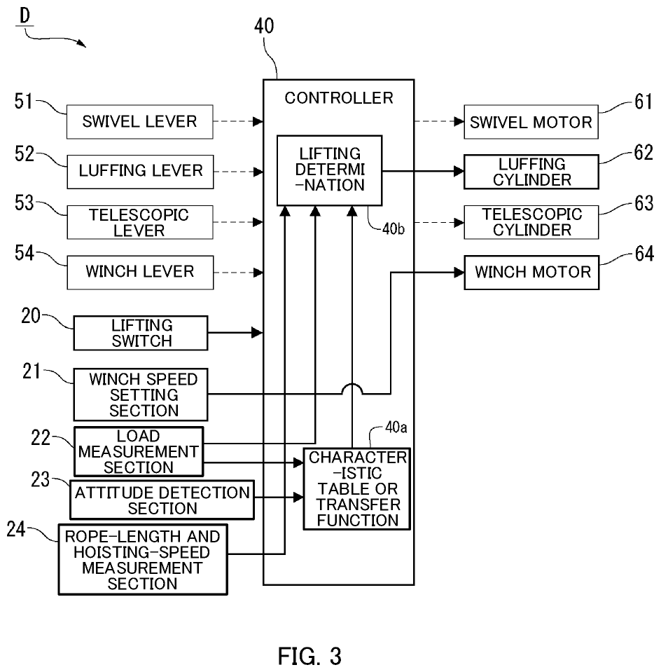

Next, a configuration of a control system of lifting control apparatus D of the present embodiment will be described using a block diagram of FIG. 3. Lifting control apparatus D is configured around controller 40 as a control section. Controller 40 is a general-purpose microcomputer including an input port, an output port, an arithmetic apparatus, and the like. Controller 40 receives an operation signal from operation levers 51 to 54 (swivel lever 51, luffing lever 52, telescopic lever 53, and winch lever 54), and controls actuators 61 to 64 (swivel motor 61, luffing cylinder 62, telescopic cylinder 63, and winch motor 64) via a control valve (not illustrated).

Further, lifting switch 20, winch speed setting section 21, load measurement section 22, attitude detection section 23, and rope-length and hoisting-speed measurement section 24 are connected to controller 40 of the present embodiment. Lifting switch 20 is used to start and stop lifting control. Winch speed setting section 21 is used to set a speed of winch 13 in lifting control. Load measurement section 22 is used to measure a load acting on boom 14. Attitude detection section 23 is used to detect an attitude of boom 14. Rope-length and hoisting-speed measurement section 24 measures a rope length of wire rope 16.

Lifting switch 20 is an input apparatus for instructing the start or stop of lifting control. For example, lifting switch 20 can be configured to be added to a safety apparatus of rough terrain crane 1, and is preferably disposed in cockpit 18.

Winch speed setting section 21 is an input apparatus for setting the speed of winch 13 in lifting control. Examples of winch speed setting section 21 include those of a type in which an appropriate speed is selected from speeds set in advance and those of a type in which a speed is inputted with a ten key. Further, in the same manner as lifting switch 20, winch speed setting section 21 can be configured to be added to the safety apparatus of rough terrain crane 1, and is preferably disposed in cockpit 18. Adjusting the speed of winch 13 by winch speed setting section 21 described above makes it is possible to adjust the time required for lifting control.

Load measurement section 22 is a measurement apparatus that measures a load acting on boom 14. For example, load measurement section 22 can be pressure gauge 22 that measures pressure acting on luffing cylinder 62. A pressure signal measured by pressure gauge 22 is transmitted to controller 40.

Attitude detection section 23 is a measurement apparatus that detects the attitude of boom 14, and is formed of luffing angle meter 231 and luffing angular speed meter 232. Luffing angle meter 231 measures a luffing angle of boom 14. Luffing angular speed meter 232 measures a luffing angular speed. Specifically, a potentiometer can be used as luffing angle meter 231. Further, a stroke sensor attached to luffing cylinder 15 can be used as luffing angular speed meter 232. A luffing angle signal measured by luffing angle meter 231 and a luffing angular speed signal measured by luffing angular speed meter 232 are transmitted to controller 40.

Rope-length and hoisting-speed measurement section 24 measures a rope length of wire rope 16, and can be, for example, a rotational speed meter (so-called rotary encoder) that measures a rotational speed of winch motor 64. This rotational speed meter directly measures a rotational speed of winch 13 and therefore has an extremely good responsiveness. Note that, since a temporal change in a rope length can also be detected by rope-length and hoisting-speed measurement section 24 as a matter of course, rope-length and hoisting-speed measurement section 24 can also be used as a hoisting-speed measurement section.

Controller 40 is a control section that controls the operations of boom 14 and winch 13. When a suspended load is lifted by turning lifting switch 20 on to hoist winch 13, controller 40 predicts a variation in a luffing angle of boom 14 based on a temporal change in a load measured by load measurement section 22, and causes boom 14 to be luffed up and down so as to compensate for the predicted variation.

More specifically, controller 40 includes, as functional sections, selection function section 40a for a characteristic table or transfer function, and lifting determination function section 40b that stops lifting control by determining whether lifting has been actually performed.

Selection function section 40a for a characteristic table or transfer function receives inputs of an initial pressure value from pressure gauge 22 as the load measurement section and an initial luffing angle value from luffing angle meter 23 as the attitude detection section, and determines a characteristic table or transfer function to be applied. Here, as the transfer function, a relationship using linear coefficient a can be applied as follows.

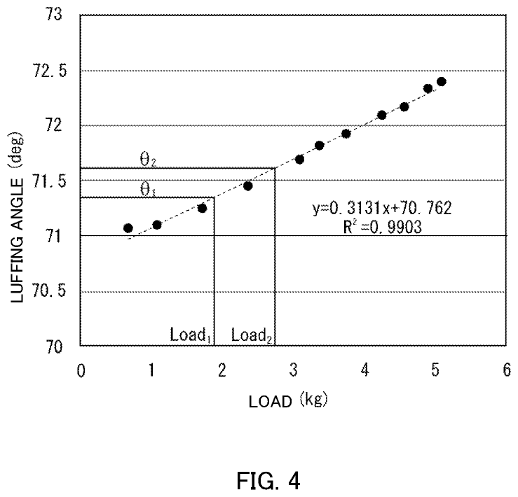

First, as illustrated in a load-luffing angle graph of FIG. 4, it is known that a load and a luffing angle (distal end-ground angle) have a linear relationship in a case where the position of a distal end of a boom is adjusted to always come directly above a suspended load such that a load swing does not occur. Assuming that Load₁ has changed to Load₂ between time t₁ and time t₂ during lifting,

[1]

APPROXIMATE EXPRESSION θ=a·Load+b

t₁θ₁=a·Load₁+b

t₂θ₂=a·Load₂+b (Expression 1).

When a difference equation is determined from a difference between two expressions,

[2]

θ₂−θ₁=a(Load₂−Load₁)

Δθ=a·ΔLoad (Expression 2).

In order to control the luffing angle, it is necessary to give the luffing angular speed.

$$\begin{matrix} [ 3 ] & \\ V \text{?} = \frac{Δ θ}{( {t}_{2} - {t}_{1} )} = a \cdot \frac{Δ Load}{Δ t} = a \cdot {\dot{L}}_{Load} \\ \text{?} \text{indicates text missing or illegible when filed} & ( Expression 3 )\end{matrix}$$

where a represents a constant (linear coefficient).

That is, in luffing angle control, a temporal change in a load (differentiation) is inputted.

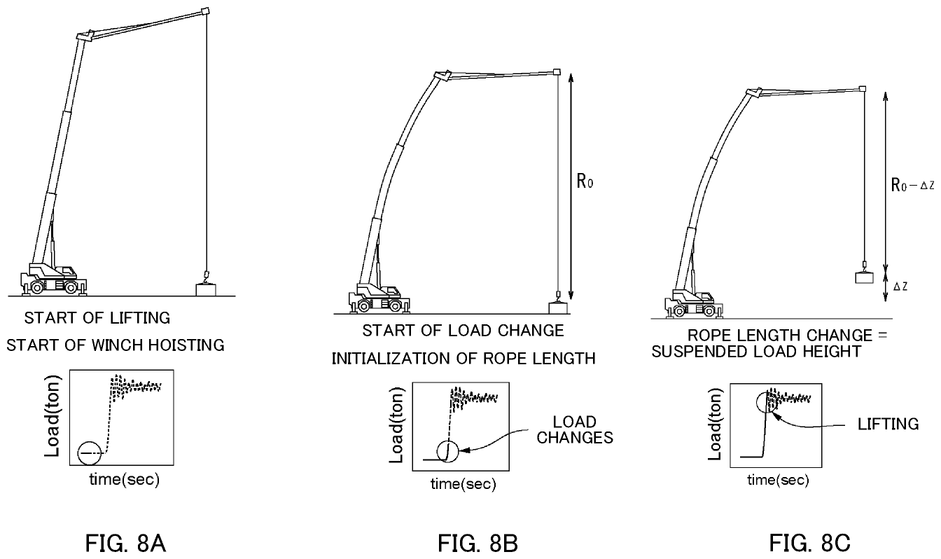

Lifting determination function section 40b monitors time-series data of a load value calculated from a pressure signal from pressure gauge 22 as the load measurement section, and determines whether lifting has been performed or not. The method of lifting determination will be described later using FIGS. 8A to 8C.

(Overall Block Diagram)

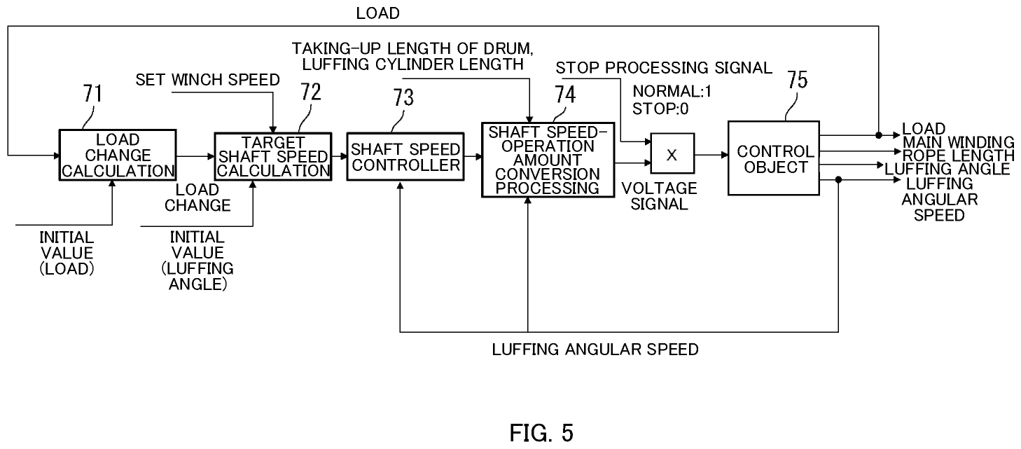

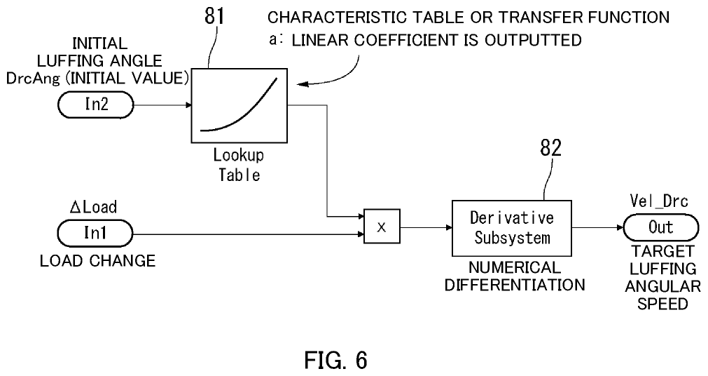

Next, input-output relationships between elements in their entirety including lifting control of the present embodiment will be described in detail using a block diagram of FIG. 5. First, in load change calculation section 71, a load change is calculated based on time-series data of a load measured by load measurement section 22. The calculated load change is inputted into target shaft speed calculation section 72. The input-output relationship in target shaft speed calculation section 72 will be described later using FIG. 6.

In target shaft speed calculation section 72, a target shaft speed is calculated based on an initial luffing angle value, a set winch speed, and an inputted load change. The target shaft speed herein is a target luffing angular speed (and, although not essential, a target winch speed). The calculated target shaft speed is inputted into shaft speed controller 73. The control in the first half portion to this point represents processing related to the lifting control of the present embodiment.

Thereafter, the processing passes through shaft speed controller 73 and shaft speed-operation amount conversion processing section 74, and then an operation amount is inputted into control object 75. This control in the second half portion represents processing related to normal control, and feedback control is performed based on a measured luffing angular speed.

(Block Diagram of Lifting Control)

Next, especially the input-output relationship of elements in target shaft speed calculation section 72 in the lifting control will be described using a block diagram of FIG. 6. First, an initial luffing angle value is inputted into selection function section 81 (40a) for a characteristic table or transfer function. In selection function section 81, constant (linear coefficient) a that is most appropriate is selected using a characteristic table (Lookup Table) or transfer function.

Then, in numerical differentiation section 82, numerical differentiation of a load change (differentiation with respect to time) is performed and a result of the numerical differentiation is multiplied by constant a, thereby calculating a target luffing angular speed. That is, the target luffing angular speed is calculated by execution of the calculation of expression 3 described above. Thus, in the control of the target luffing angular speed, feed forward control is performed using a characteristic table (or transfer function).

(Flowchart)

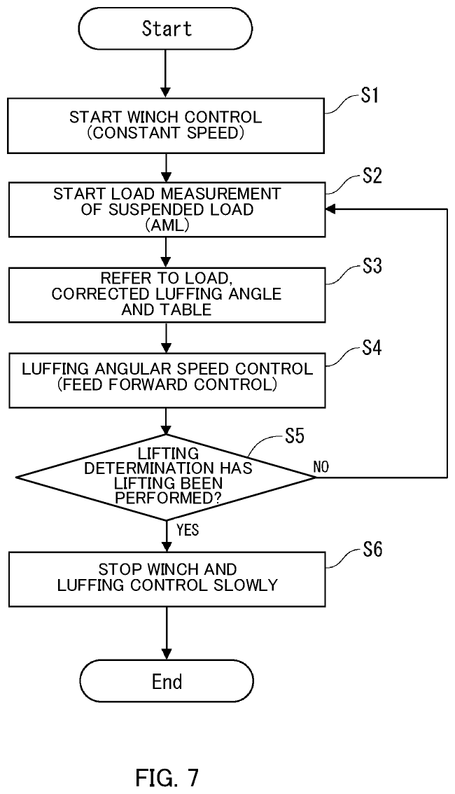

Next, an overall flow of the lifting control of the present embodiment will be described using a flowchart of FIG. 7.

First, an operator presses lifting switch 20 to start lifting control (START). At this time, a target speed of winch 13 is set via winch speed setting section 21 in advance before or after the start of the lifting control. Then, controller 40 starts winch control at the target speed (step S1).

Next, winch 13 is hoisted and load measurement of a suspended load is started by load measurement section 22 at the same time, and a load value is inputted into controller 40 (step S2). Then, selection function section 40a receives inputs of an initial load value and an initial luffing angle value from luffing angle meter 23 as the attitude detection section, and determines a characteristic table or transfer function to be applied (step S3).

Next, controller 40 calculates a luffing angular speed based on the characteristic table or transfer function to be applied and a load change (step S4). That is, luffing angular speed control is performed by feed forward control.

Then, it is determined based on time-series data of a measured load whether lifting has been performed or not (step S5). Note that, the determination method will be described later. In a case where lifting has not been performed as a result of the determination (NO in step S5), the flow returns to step S2, and the feed forward control based on the load is repeated (steps S2 to S5).

In a case where lifting has been performed as a result of the determination (YES in step S5), the lifting control is slowly stopped (step S6). That is, rotation driving of winch 13 by the winch motor is stopped while decreasing the speed, and luffing driving by luffing cylinder 62 is stopped while decreasing the speed.

(Lifting Determination)

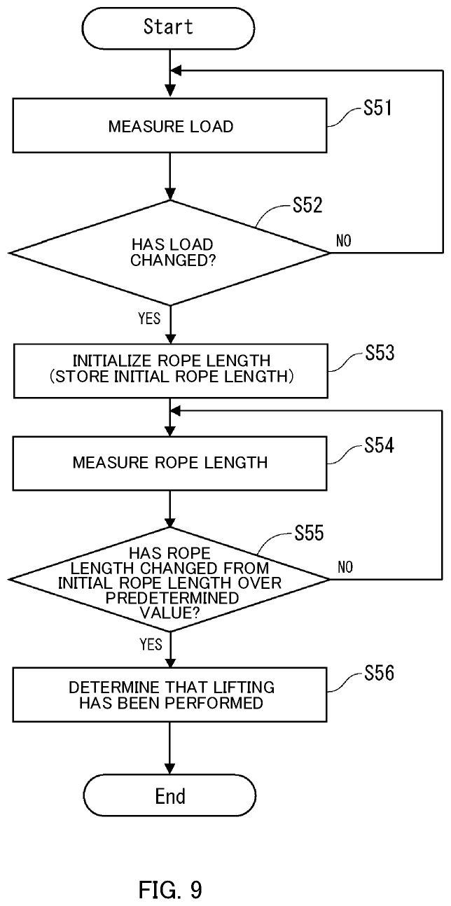

Next, lifting determination apparatus C and a lifting determination method of the present embodiment will be described in detail using FIGS. 8A to 8C and 9. Lifting determination apparatus C is formed of boom 14, winch 13, load measurement section 22, rope-length and hoisting-speed measurement section 24, and controller 40 as the control section that controls boom 14 and winch 13.

Further, when lifting of a suspended load is performed by hoisting winch 13 in lifting control, controller 40 of the present embodiment performs lifting determination based on a temporal change in a measured load and a temporal change in a measured rope length.

Specifically, when lifting of a suspended load is performed by hoisting winch 13, controller 40 as the control section sets, as an initial rope length, a rope length at a time when a measured load starts to change, and when a rope length becomes shorter than a threshold value set from the initial rope length, controller 40 determines that the lifting has been performed.

Alternatively, when lifting of a suspended load is performed by hoisting winch 13, controller 40 as the control section sets, as an initial hoisting speed, a temporal change in a rope length at a time when a measured load starts to change, and when a hoisting speed that is the temporal change in the rope length becomes faster than a threshold value set from the initial hoisting speed, controller 40 determines that the lifting has been performed.

That is, as illustrated in FIG. 8A, wire rope 16 is loose at the time of start of lifting even when winch 13 is hoisted, so that almost no load acts. When winch 13 is hoisted as it is, the self-weights of wire rope 16 and hook 17 act. Thereafter, when winch 13 is further hoisted, a load is increasing (changing) while causing a deflection in boom 14 as illustrated in FIG. 8B. Then, when the load has changed over a predetermined threshold value, the rope length is initialized. Thereafter, when winch 13 is further hoisted, the rope length becomes suddenly shorter after a maximum deflection occurs in boom 14 as illustrated in FIG. 8C. Accordingly, a time when the rope length has suddenly changed in this way can be captured and determined as a lifting time.

Alternatively, when a load has changed over a predetermined threshold value, a temporal change in the rope length, that is, a hoisting speed is initialized. Thereafter, when winch 13 is further hoisted, the hoisting speed becomes suddenly faster after a maximum deflection occurs in boom 14 as illustrated in FIG. 8C. Accordingly, a time when the hoisting speed has suddenly changed in this way can be captured and determined as a lifting time.

That is, the lifting determination method of the present embodiment includes, hoisting winch 13; measuring a load; measuring a rope length of wire rope 16; storing, as an initial rope length, the rope length at a time when the load starts to change; and determining that lifting has been performed when the rope length becomes shorter than a threshold value set from the initial rope length.

Alternatively, the lifting determination method of the present embodiment includes: hoisting winch 13, measuring a load; measuring a hoisting speed of wire rope 16; storing, as an initial hoisting speed, the hoisting speed at a time when the load starts to change; and determining that lifting has been performed when the hoisting speed becomes faster than a threshold value set from the initial hoisting speed.

Hereinafter, the lifting determination method will be described using a flowchart of FIG. 9. Note that, only the lifting determination method will be described here using the flowchart of FIG. 9. The lifting control method in its entirety is as described in FIG. 7. That is, of the flowchart of FIG. 7, the content of the lifting determination in step S5 will be described here.

As illustrated in the flowchart of FIG. 9, this lifting determination method is divided into processing in a first half part in which a load change is captured (steps S51 and S52) and processing in a second half part in which a rope length (or hoisting speed) change is captured (steps S53 to S55). Hereinafter, for convenience of description, it is assumed that a load is measured in step S51.

In the first half part, the load is first measured by load measurement section 22, and controller 40 monitors time series data of the load (step S51). Then, when the load has changed over a threshold value (YES in step S52), controller 40 initializes a rope length (step S53). That is, controller 40 stores rope length R0 at a time when the load exceeds the threshold value. When the load has not changed over the threshold value (NO in step S52), on the other hand, controller 40 continues to measure the load (steps S51 and S52).

In the second half part, the rope length is first measured by rope-length and hoisting-speed measurement section 24, and controller 40 monitors time series data of the rope length (step S54). Then, when the rope length becomes shorter than initial rope length R0 over a threshold value (YES in step S55), controller 40 determines that lifting has been performed (step S56). When the rope length does not become shorter than initial rope length R0 over the threshold value (NO in step S55), on the other hand, controller 40 continues to measure the rope length (steps S54 and S55).

Alternatively, although not illustrated, when a temporal change in the rope length, that is, a hoisting speed, becomes faster than initial hoisting speed V0 over a threshold value (which corresponds to YES in step S55), controller 40 determines that lifting has been performed (which corresponds to step S56). When the hoisting speed does not become faster than initial hoisting speed V0 over the threshold value (which corresponds to NO in step S55), on the other hand, controller 40 continues to measure the rope length (hoisting speed) (which corresponds to steps S54 and S55).

In this way, lifting is determined by processing and determination in which a load change is captured (steps S51 and S52) and processing and determination in which a rope length (or hoisting speed) change is captured (S53 to S55).

### Effects

Next, effects attainable by lifting determination apparatus C, lifting control apparatus D, and rough terrain crane 1 as the mobile crane in the present embodiment will be enumerated and described.

(1) As described above, lifting determination apparatus C of the present embodiment includes: boom 14 configured to be freely luffed up and down; winch 13 that hoists and lowers a suspended load via wire rope 16; load measurement section 22 that measures a load acting on boom 14; rope-length measurement section 24 that measures a rope length of wire rope 16; and controller 40 that controls boom 14 and winch 13. When lifting of the suspended load is performed by hoisting winch 13, controller 40 determines the lifting based on a temporal change in the measured load and a temporal change in the measured rope length. Given such a configuration, lifting determination apparatus C is capable of quickly performing lifting determination by a simple method while suppressing a load swing.

That is, while a slight time difference occurs between a time when a load change is captured and a time when lifting is actually performed due to a characteristic of load measurement section 22, lifting determination apparatus C starts to monitor lifting therebetween, and captures lifting itself by rope-length and hoisting-speed measurement section 24 having good responsiveness. Thus, lifting determination apparatus C has good responsiveness with a simple configuration. Further, lifting determination apparatus C can also be utilized for coordinate setting in route control based on a rope length-suspended load height relation.

(2) Specifically, when the lifting of the suspended load is performed by hoisting winch 13, controller 40 sets, as initial rope length R0, the rope length at a time when the measured load starts to change. When the rope length becomes shorter than a threshold value set from initial rope length R0, controller 40 determines that the lifting has been performed.

(3) Alternatively, when the lifting of the suspended load is performed by hoisting winch 13, controller 40 sets, as initial hoisting speed V0, a temporal change in the rope length at a time when the measured load starts to change. When a hoisting speed that is the temporal change in the rope length becomes faster than a threshold value set from initial hoisting speed V0, controller 40 determines that the lifting has been performed.

(4) Further, lifting control apparatus D of the present embodiment includes boom 14, winch 13, load measurement section 22, and controller 40 as a control section that controls boom 14 and winch 13. When the lifting of the suspended load is performed by hoisting winch 13, controller 40 determines a variation in a luffing angle of boom 14 based on the temporal change in the measured load, and causes boom 14 to be luffed up and down so as to compensate for the variation. Given such a configuration, lifting control apparatus D is capable of quickly lifting a suspended load while suppressing a load swing.

That is, lifting control apparatus D of the present embodiment pays attention to the fact that a load-luffing angle relationship is a linear relationship, and performs feed forward control based only on a temporal change in a load value, thereby being capable of quickly lifting a suspended load without performing complicated feedback control as in the related art.

(5) In addition, lifting control apparatus D preferably further includes attitude detection section 23 that measures an attitude of boom 14, and controller 40 preferably selects a corresponding characteristic table or transfer function based on an initial value of the measured attitude of boom 14 and an initial value of the measured load, and determines the variation in the luffing angle of boom 14 from the temporal change in the measured load by using the characteristic table or transfer function.

With such a configuration, lifting control apparatus D is capable of quickly performing lifting without a load swing by hoisting winch 13 at a constant speed at the time of start of lifting control and calculating a luffing angle control amount from a characteristic table (or transfer function) in accordance with a load change to perform feed forward control. In addition, parameters to be adjusted become fewer so that adjustment at the time of shipment can be quickly and easily performed.

(6) Further, when the lifting of the suspended load is performed by hoisting winch 13, controller 40 preferably causes winch 13 to be hoisted at a constant speed. With such a configuration, lifting control apparatus D is capable of facilitating lifting determination by suppressing an influence of disturbance such as an inertial force to stabilize a response (measured load value).

(7) Further, rough terrain crane 1 that is a mobile crane of the present embodiment includes lifting determination apparatus C that is any of those described above, or lifting control apparatus D that is any of those described above. Accordingly, rough terrain crane 1 is capable of quickly lifting a suspended load while suppressing a load swing.

(8) Further, a lifting determination method of the present embodiment includes: hoisting winch 13; measuring a load; measuring a rope length of wire rope 16; storing, as initial rope length R0, the rope length at a time when the load starts to change; and determining that lifting has been performed, when the rope length becomes shorter than a threshold value set from initial rope length R0. Accordingly, the lifting determination method is capable of quickly performing lifting determination by a simple method while suppressing a load swing.

(9) Further, another lifting determination method of the present embodiment includes: hoisting winch 13; measuring a load; measuring a hoisting speed of wire rope 16; storing, as initial hoisting speed V0, the hoisting speed at a time when the load starts to change; and determining that lifting has been performed when the hoisting speed becomes faster than a threshold value set from the initial hoisting speed V0. Accordingly, the other lifting determination method is capable of quickly performing lifting determination by a simple method while suppressing a load swing.

Although the embodiment of the present invention has been described in detail with reference to the drawings thus far, specific configurations are not limited to those in this embodiment, and design changes to the extent that the changes do not deviate from the gist of the present invention are included in the present invention.

For example, although description has not specially been given in the embodiment, lifting control apparatus D of the present invention is applicable even in a case where lifting is performed using a main winch as winch 13 and even in a case where lifting is performed using a sub winch.

### REFERENCE SIGNS LIST

C: Lifting determination apparatus; D: Lifting control apparatus; a: Linear coefficient:
1: Rough terrain crane; 10: Vehicle body; 12: Swivel base;
13: Winch; 14: Boom; 16: Wire: 17: Hook;
20: Lifting switch:
21: Winch speed setting section;
22: Pressure gauge (load measurement section);
23: Luffing angle meter (attitude detection section);
24: Rope-length and hoisting-speed measurement section;
40: Controller;
40a: Selection function section: 40b: Lifting determination function section;
51: Swivel lever: 52: Luffing lever:
53: Telescopic lever: 54: Winch lever:
61: Swivel motor; 62: Luffing cylinder:
63: Telescopic cylinder; 64: Winch motor

1. A lifting determination apparatus, comprising:
a boom configured to be freely luffed up and down;
a winch that hoists and lowers a suspended load via a wire rope;
a load measurement section that measures a load acting on the boom;
a rope-length measurement section that measures a rope length of the wire rope; and
a control section that controls the boom and the winch, wherein
when lifting of the suspended load is performed by hoisting the winch, the control section determines the lifting based on a temporal change in the measured load and a temporal change in the measured rope length.

2. The lifting determination apparatus according to claim 1, wherein
when the lifting of the suspended load is performed by hoisting the winch, the control section sets, as an initial rope length, the rope length at a time when the measured load starts to change, and when the rope length becomes shorter than a threshold value set from the initial rope length, the control section determines that the lifting has been performed.

3. The lifting determination apparatus according to claim 1, wherein
when the lifting of the suspended load is performed by hoisting the winch, the control section sets, as an initial hoisting speed, a temporal change in the rope length at a time when the measured load starts to change, and when a hoisting speed becomes faster than a threshold value set from the initial hoisting speed, the control section determines that the lifting has been performed, the hoisting speed being the temporal change in the rope length.

4. A lifting control apparatus, comprising the lifting determination apparatus according to claim 1, wherein
when the lifting of the suspended load is performed by hoisting the winch, the control section determines a variation in a luffing angle of the boom based on the temporal change in the measured load, and causes the boom to be luffed up and down so as to compensate for the variation.

5. The lifting control apparatus according to claim 4, further comprising an attitude detection section that measures an attitude of the boom, wherein
the control section selects a corresponding characteristic table or transfer function based on an initial value of the measured attitude of the boom and an initial value of the measured load, and determines the variation in the luffing angle of the boom from the temporal change in the measured load by using the characteristic table or transfer function.

6. The lifting control apparatus according to claim 4, wherein
when the lifting of the suspended load is performed by hoisting the winch, the control section causes the winch to be hoisted at a constant speed.

7. A mobile crane, comprising the lifting determination apparatus according to claim 1.

8. A mobile crane, comprising the lifting control apparatus according to claim 4.

9. A lifting determination method executed by a processor mounted on a crane, comprising:
hoisting a winch;
measuring a load;
measuring a rope length of a wire rope;
storing, as an initial rope length, the rope length at a time when the load starts to change; and
determining that lifting has been performed when the rope length becomes shorter than a threshold value set from the initial rope length.

10. A lifting determination method executed by a processor mounted on a crane, comprising:
hoisting a winch;
measuring a load;
measuring a hoisting speed of a wire rope;
storing, as an initial hoisting speed, the hoisting speed at a time when the load starts to change; and
determining that lifting has been performed when the hoisting speed becomes faster than a threshold value set from the initial hoisting speed.
